(19) United States
(12) Patent Application Publication
(10) Pub. No.: US 2014/0052985 A1
(43) Pub. Date: Feb. 20, 2014

(54) METHODS FOR PROVIDING REQUESTED DATA FROM A STORAGE DEVICE TO A DATA CONSUMER AND STORAGE DEVICES

(71) Applicant: AGENCY FOR SCIENCE, TECHNOLOGY AND RESEARCH, Singapore (SG)

(72) Inventor: Yanjiang YANG, Singapore (SG)

(73) Assignee: AGENCY FOR SCIENCE, TECHNOLOGY AND RESEARCH, Singapore (SG)

(21) Appl. No.: 13/963,084

(22) Filed: Aug. 9, 2013

(30) Foreign Application Priority Data
Aug. 15, 2012 (SG) 201206073-7

(51) Int. Cl. H04L 29/06

(52) U.S. Cl. CPC H04L 63/0428
USPC 713/168

(57) ABSTRACT

According to various embodiments, a method for providing requested data from a storage device to a data consumer may be provided. The method may include: determining a helper key for the data consumer; determining encrypted data corresponding to the requested data from a memory of the storage device; determining pre-processed data based on the encrypted data and the helper key, wherein the pre-processed data is encrypted and configured to be decrypted using a private key of the data consumer; and transmitting the pre-processed data to the data consumer.

### CROSS-REFERENCE TO RELATED APPLICATION

The present application claims the benefit of the Singapore patent application No. 201206073-7 filed on 15 Aug. 2012, the entire contents of which are incorporated herein by reference for all purposes.

### TECHNICAL FIELD

Embodiments relate generally to methods for providing requested data from a storage device to a data consumer and storage devices.

### BACKGROUND

Cloud storage service may be a powerful platform for data sharing. Such a cloud storage service may represent a dynamic multi-user data sharing setting, where multiple users are authorized by the data owner to access the shared data, and each with different access privileges.

Thus, there may be a need for efficient access control for cloud storage services.

### SUMMARY

According to various embodiments, a method for providing requested data from a storage device to a data consumer may be provided. The method may include: determining a helper key for the data consumer; determining encrypted data corresponding to the requested data from a memory of the storage device; determining pre-processed data based on the encrypted data and the helper key, wherein the pre-processed data is encrypted and configured to be decrypted using a private key of the data consumer; and transmitting the pre-processed data to the data consumer.

According to various embodiments, a storage device may be provided. The storage device may include: a helper key determination circuit configured to determine a helper key for a data consumer requesting data; an encrypted data determination circuit configured to determine encrypted data corresponding to the requested data from a storage of the storage device; a pre-processed data determination circuit configured to determine pre-processed data based on the encrypted data and the helper key, wherein the pre-processed data is encrypted and configured to be decrypted using a private key of the data consumer; and a transmitter configured to transmit the pre-processed data to the data consumer.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows a flow diagram illustrating a method for providing requested data from a storage device (for example a cloud) to a data consumer according to various embodiments;

FIG. 1B shows a storage device according to various embodiments;

FIG. 1C shows a storage device according to various embodiments;

FIG. 2 shows a cloud system according to various embodiments; and

FIG. 3 shows an illustration depicting the construction of a tree structure according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the storage device as described in this description may include a memory which is for example used in the processing carried out in the storage device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Cloud storage service may be a powerful platform for data sharing. Such a cloud storage service may represent a dynamic multi-user data sharing setting, where multiple users are authorized by the data owner to access the shared data, and each with different access privileges.

Thus, there may be a need for efficient access control for cloud storage services.

The cloud-based data sharing setting may pose challenges on access control. Commonly used access control mechanisms, such as the certificate revocation list (CRL) and the role-based access control method may be good at implementing access control in terms of assigning different access privileges to different users, but they may not be applicable in some cloud-based data sharing applications. This may be because commonly used access control mechanisms may assume that the data owner controls the server, and they belong to the same trust domain. However, this assumption may not hold in the public cloud storage setting, where the data owner may have no control over the cloud server. Another challenge may arise due to privacy concerns, as the data owner usually uploads encrypted data to the cloud storage. This may mandate a key distribution mechanism such that a user can only decrypt the data that she is allowed to access, and the revocation mechanism must prevent a revoked user from accessing unauthorized data. Another issue may stem from the application setting where it may be the cloud server that offers the online data access service, rather than the owner himself or herself. Nonetheless, it may be desirable to minimize the cloud server's involvement in access control, in the sense that the cloud server may only perform simple tasks without being aware of the context and making intelligent decisions.

Several schemes may commonly be used to address the access control for cloud storage. These schemes may support fine-grained access control by leveraging attribute-based encryption algorithms where a set of attributes (or policies) are associated with a user's decryption key. An example of attributes may be: {Company A, Product Department, Senior Engineer, Project 1}; this set of attributes may define a senior engineer in the product department of company A who partakes in project 1. An example of policies may be: (Company Â Human Resource Department̂ Manager)∪(Company B̂ Human Resource Department̂ Senior Manager); this policy may define that either a manager from the human resource department of company A or a senior manager from the human resource department of company B can access. A ciphertext enclosing a set of policies (or attributes) may only be decrypted successfully when the key's and the ciphertext's respective attributes and policies have a match. A user's privilege revocation may be achieved via data re-encryption with a new key which are securely delivered to authorized users.

This approach may inflict a heavy overhead on the cloud server in case of revocation. The cloud server may have to get the updated key from the owner and may perform re-encryption for possibly all data items. The server may also have to maintain all user revocation states. Although the cloud service may be geared to accommodate high and elastic demands from users, it may always be desirable to accomplish the same security functionality with a lower computation cost.

According to various embodiments, systems and methods for access control for cloud storage services may be provided.

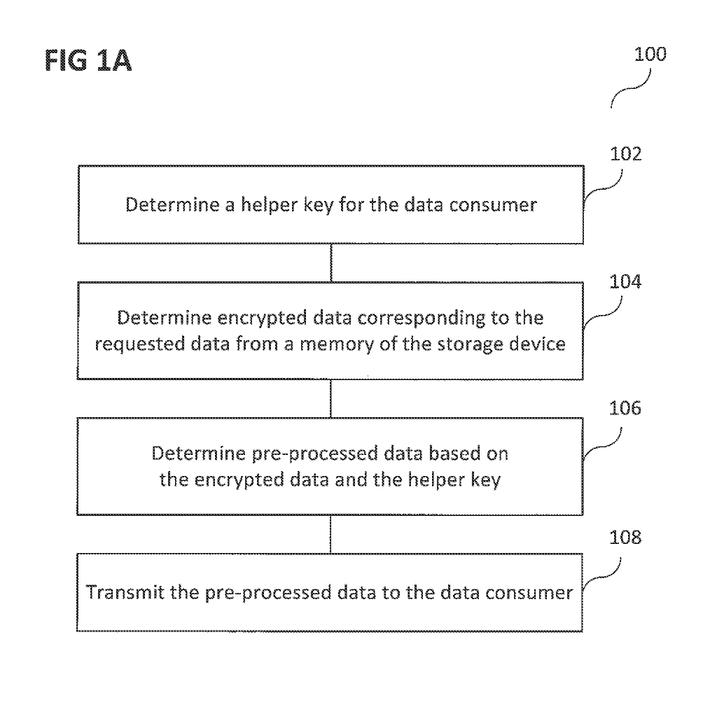

FIG. 1A shows a flow diagram 100 illustrating a method for providing requested data (which may also be referred to as a record) from a storage device (for example a cloud or a cloud storage or a cloud storage device or a cloud storage system) to a data consumer according to various embodiments. In 102, a helper key for the data consumer may be determined. In 104, encrypted data corresponding to the requested data may be determined (or received) from a memory of the storage device. In 106, pre-processed data may be determined based on the encrypted data and the helper key. The pre-processed data is encrypted and may be configured to be decrypted using a private key of the data consumer. In 108, the pre-processed data may be transmitted to the data consumer.

In other words, a storage device may store encrypted data, and these data may be decrypted by a user only after the storage device has performed pre-determined pre-processing based on a user specific key (for example called helper key) on the encrypted data.

According to various embodiments, the helper key may be specific for the data consumer.

According to various embodiments, the method may further include receiving the encrypted data from a data owner (wherein for example the data owner may have provided the encrypted data to the storage device).

According to various embodiments, the method may further include determining the helper key from a data owner based on attributes of the data consumer and a master key.

According to various embodiments, the method may further include determining the encrypted data based on a tree-structure based on user attributes.

According to various embodiments, the tree-structure may include a root node with a tree-structure based on the (actual) user attributes as a sub-tree and a dummy attribute as an extra leaf.

According to various embodiments, the pre-processed data may be configured to only (or exclusively) be decrypted using the private key of the data consumer.

According to various embodiments, the method may further include determining the pre-processed data based on a pre-decryption of the encrypted data based on the helper key.

According to various embodiments, the method may further include determining the pre-processed data based on a re-encryption of the encrypted data based on the helper key.

According to various embodiments, the method may further include receiving from a data owner an instruction to delete the helper key. According to various embodiments, the method may further include deleting the helper key.

FIG. 1B shows a storage device 110 (for example a cloud or a cloud storage or a cloud storage device or a cloud storage system) according to various embodiments. The storage device 110 may include a helper key determination circuit 112 configured to determine a helper key for a data consumer requesting data. The storage device 110 may further include an encrypted data determination circuit 114 configured to determine encrypted data corresponding to the requested data from a storage of the storage device. The storage device 110 may further include a pre-processed data determination circuit 116 configured to determine pre-processed data based on the encrypted data and the helper key. The pre-processed data may be encrypted and may be configured to be decrypted using a private key of the data consumer. The storage device 110 may further include a transmitter 118 configured to transmit the pre-processed data to the data consumer. The helper key determination circuit 112, the encrypted data determination circuit 114, the pre-processed data determination circuit 116, and the transmitter 118 may be coupled with each other, like indicated by lines 120, for example electrically coupled, for example using a line or a cable, and/or mechanically coupled.

According to various embodiments, the helper key may be specific (or exclusive) for the data consumer.

FIG. 1C shows a storage device 122 (for example a cloud) according to various embodiments. Various portions of the storage device 122 may be similar or identical to portions of the storage device 110 of FIG. 1B, so that the same reference signs may be used and duplicate description may be omitted. The storage device 112 may, similar to the storage device 110 of FIG. 1B, include a helper key determination circuit 112 configured to determine a helper key for a data consumer requesting data. The storage device 122 may, similar to the storage device 110 of FIG. 1B, further include an encrypted data determination circuit 114 configured to determine encrypted data corresponding to the requested data from a storage of the storage device. The storage device 122 may, similar to the storage device 110 of FIG. 1B, further include a pre-processed data determination circuit 116 configured to determine pre-processed data based on the encrypted data and the helper key. The pre-processed data is encrypted and may be configured to be decrypted using a private key of the data consumer. The storage device 122 may, similar to the storage device 110 of FIG. 1B, further include a transmitter 118 configured to transmit the pre-processed data to the data consumer. The storage device 122 may further include a receiver 124, like will be described in more detail below. The storage device 122 may further include a helper key deletion circuit 126, like will be described in more detail below. The helper key determination circuit 112, the encrypted data determination circuit 114, the pre-processed data determination circuit 116, the transmitter 118, the receiver 124, and the helper key deletion circuit 126 may be coupled with each other, like indicated by lines 128, for example electrically coupled, for example using a line or a cable, and/or mechanically coupled.

According to various embodiments, the receiver 124 may be configured to receive the encrypted data from a data owner.

According to various embodiments, the helper key determination circuit 122 may further be configured to determine the helper key from a data owner based on attributes of the data consumer and a master key.

According to various embodiments, the pre-processed data determination circuit 116 may further be configured to determine the encrypted data based on a tree-structure based on user attributes.

According to various embodiments, the tree-structure may include a root node with a tree-structure based on the user attributes as a sub-tree and a dummy attribute as an extra leaf.

According to various embodiments, the pre-processed data may be configured to only be decrypted using the private key of the data consumer.

According to various embodiments, the pre-processed data determination circuit 116 may further be configured to determine the pre-processed data based on a pre-decryption of the encrypted data based on the helper key.

According to various embodiments, the pre-processed data determination circuit 116 may further be configured to determine the pre-processed data based on a re-encryption of the encrypted data based on the helper key.

According to various embodiments, the receiver 124 may be configured to receive from a data owner an instruction to delete the helper key.

According to various embodiments, the helper key deletion circuit 126 may be configured to delete the helper key.

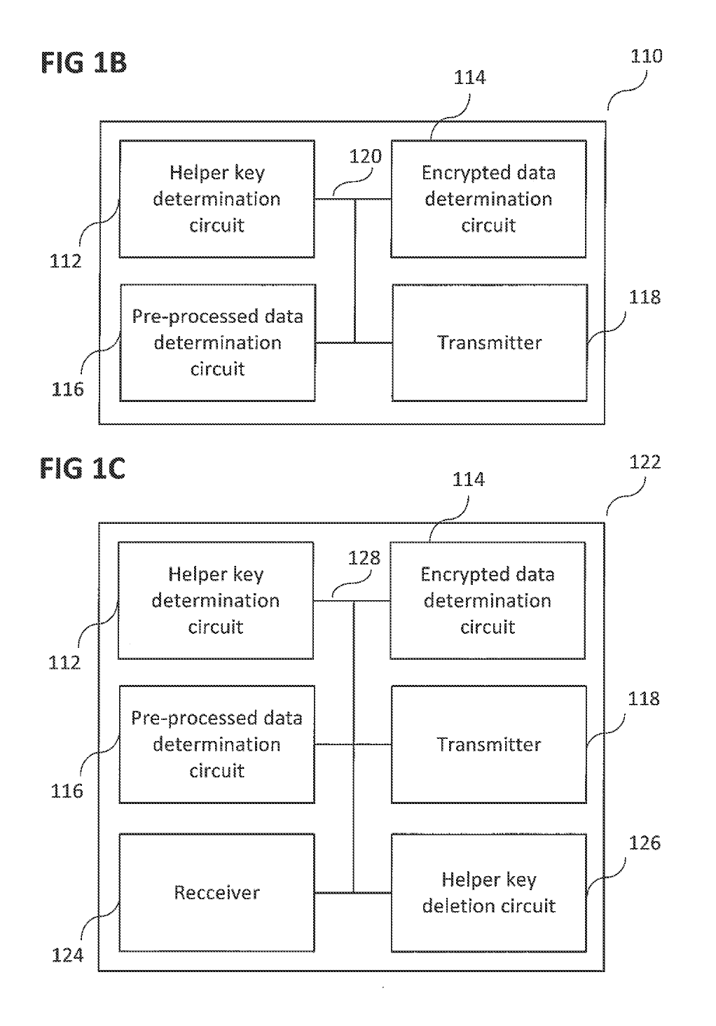

FIG. 2 shows a system 200 according to various embodiments. In the use scenario of cloud computing as shown in FIG. 2, a data owner 206 may outsource (like indicated by arrow 210) his or her data to a cloud 202 including a database 204 and may authorize (like indicated by arrow 212) a group of data consumers 208 (in other words: users) to access (like indicated by arrow 214) the data (for example the data in the database 204). As such, the system 200 may include the following players: the Data Owner (DO) 206, the Cloud (CLD) 202, and a set of Data Consumers 208 (which may also be referred to as users 208). Dashed arrows (like arrow 216) may indicate processing carried out during an offline phase (for example during a phase when the users 208 do not yet access the data). For example, outsourcing 210 and authorizing 212 may be performed offline. A double solid line arrow (like arrow 218) may indicate processing carried out during an online phase (for example during a phase when the users 208 access the data, like indicated by arrow 214).

According to various embodiments, the data owner 206 may outsource his or her data to the cloud 202 for storage (for example in data base 204) and management (by instructing the cloud 202 for updating the database 204, e.g., add records or delete records). The data owner 206 may also take charge of managing authorization of the data consumers 208 to access his or her data. For security reasons, the data in outsourcing may be encrypted by the data owner 206 against the cloud 202. To facilitate the enforcement of fine-grained access control, a data record may be encrypted by associating with data encryption an access policy, in a way that users' access privileges (in other words: the access privileges of one of the data consumers 208) are specified and differentiated. Each valid data consumer 208 may be issued (or may be provided with) a decryption key by the data owner 206 according to his access right, which may be used to access the encrypted data.

To facilitate user revocation, according to various embodiments, it may be turned to the cloud (CLD) for help. For example, for each valid data consumer 208 the data owner (DO) 206 issues a helper key to CLD 202, corresponding to the consumer's 208 decryption key. As a result, CLD 202 may manage a table containing all data consumers' helper keys. A consumer's helper key may be used as follows: when the user requests an encrypted data from CLD 202, CLD first performs a pre-decryption operation using the user's helper key over the ciphertext; then return the processed ciphertext to the user 208, who performs the final decryption using his or her decryption key. Without the pre-decryption by the helper key, the user 208 may not be able to decrypt to get the actual plaintext, even given the ciphertext. Given the essential role of the helper key in the decryption procedure, to revoke a user, CLD 202 (for example when it is instructed by the data owner) simply may delete his or her helper key.

In the following, an embodiment (which may also be referred to as “Instantiation 1”) will be described. Attribute-based encryption (ABE) may be a kind of fine-grained public key encryption: in commonly used public key encryption, an encryptor encrypts a message under a public key, and the encryptor is assured that only the holder of the corresponding private key can decrypt; in comparison, in ABE, the encryptor may associate some complex access control policy with an encryption, and only those who hold decryption keys satisfying the policy may decrypt the ciphertext. The idea may be evolved into attribute-based encryption. Two categories of attribute-based encryption may be as follows: Key-Policy Attributed-Based Encryption (KP-ABE) and Ciphertext-Policy Attribute-Based Encryption (CP-ABE). For Key-Policy Attributed-Based Encryption, a ciphertext may be associated with a set of attributes while a private key is issued as per a certain access control policy. Ciphertext-Policy Attribute-Based Encryption may be the other way around such that a ciphertext is generated according to some access control policies while private keys are issued in association with attributes.

In CP-ABE (Ciphertext-Policy Attribute-Based Encryption), private decryption keys may be identified with a set S of descriptive attributes. A party wishing to encrypt a message may specify an access policy that private decryption keys must satisfy in order to decrypt, and the access policy may be expressed by an access tree.

Let T be a tree representing an access structure. Each non-leaf node of the tree may represent a threshold gate, described by its children and a threshold value. If numₓ is the number of children of a node x, and tₓ is its threshold value, then 0<tₓ<numₓ. When tₓ=1, the threshold gate is an OR gate and when tₓ=numₓ, it is an AND gate. The parent of a node x in the tree may be denoted by parent(x). att(l) may denote the attribute associated with the leave node l in the tree. The tree T may define an ordering between the children of each node, i.e., the child of a node x may be numbered from 1 to num. The function index(x) may calculate such a unique number associated with a node x.

Let T be an access tree with root r. Denote by Tₓ the subtree of T rooted at node x. Hence T=Tᵣ. When a set of attributes ¥ satisfies the access tree Tₓ, it may be denoted as Tₓ(¥)=1. Tₓ(¥) may be computed in a recursive way as follows: if x is a non-leaf node, compute T_{x′}(¥) for all child nodes x′; Tₓ(¥) returns 1 if and only if at least tₓ children return 1; if x is a leaf node, then Tₓ(¥) returns to 1 if and only if att(x)ε¥.

According to various embodiments, let G₀ be a bilinear group of order p, where p is a large prime number. G₀ may be implemented using supersingular curves. Let g, h be a generator of G₀. Let e: G₀×G₀→G₁ be a bilinear map, which may be implemented by Weil pairing or Tate pairing on elliptic curves on finite fields, where G₁ may be a multiplicative curve in a finite field of order p, which may be the foresaid prime number. The Lagrange coefficient Δ_{i,s}(x) for iεZₚ and a set S of elements in Zₚ as

$${Δ}_{i , S} = {\prod }_{j ∈ S , j \neq i} \frac{x - j}{i - j}$$

may be defined. Let H:{0,1}*→G₀ be a cryptographic hash function. The method may provide the following functions.

A. Setup: This function may be executed by a trusted authority to set up the system parameters.

A.1 may determine bilinear groups G₀, G₁ of order p, and a bilinear map e: G₀×G₀→G₁, where p is a large prime number.

A.2 may select g, which may be a random element from G₀. So chosen, g may be a generator of G₀.

A.3 may compute and set the system public key PK=[g, e(g,g)^{a}], and the master secret key MK=(g^{a}), where a may be a random number in Zₚ, where p may be the foresaid prime number.

B. KeyGen(MK, S): This may be the key generation function to generate secret keys for users, and it may be executed by a trusted authority. It may take as input a set of attributes S of a user and may output a key that corresponds to that set.

B.1 may select r, which is a random number in Zₚ*, where p is the foresaid prime number.

B.2 may select rⱼ for each attribute jεS, where each rⱼ may be a random number in Zₚ*, where p may be the foresaid prime number.

B.3 may compute the secret key SK corresponding to S as SK=[K₀=g^{a}h^{r},{Kⱼ=gᵣH(j)^{r}^{ⱼ},Kⱼ′=h^{r}^{ⱼ}}_{∀jεS}]. For example:

B.3.1 may compute K₀=g^{a}h^{r}, where α may be the secret master key and r may be selected in B.1.

B.3.2 for each jεS may compute Kⱼ=g^{r}h(j)^{r}^{ⱼ}, Kⱼ′=h^{r}^{ⱼ}, where r may be selected in B.1 and rⱼ may be selected in B.2.

B.3.3 may form SK=[K₀,K₁,K₁′, . . . , K_{|S|},K_{|S|}′].

C. Encrypt(PK, M, T): This may be the encryption function, to encrypt a message M under the access tree T using public key PK.

C.1 may construct an access tree T as per the intended access policy.

C.2 may select a polynomial qₓ for each node x (including the leaves) in the tree T, setting its degree dₓ to be dₓ=tₓ−1, where tₓ may be the threshold value. For example, these polynomials may be chosen in a top-down manner, starting from the root node R, as follows.

C.2.1 starting with the root node R the algorithm may select a random sεZₚ* and may set q_{R}(0)=s. Then it may select d_{R} other points of the polynomial q_{R} randomly to define it completely.

C.2.2 for any other node x, may set qₓ(0)=qₚₐᵣₑₙₜ₍ₓ₎(index(x)) and may choose dₓ other points randomly to completely define qₓ.

C.3 may be as follows: Let Y be the set of leaf nodes in T. Then C.3 may compute the ciphertext C as follows:

C.3.1 may compute C₀=M. e(g, g)^{a.s}, where s may be selected in C.2.1 and e(g,g)^{a} may be the public key element.

C.3.2 may compute C_{0′=g}^{s}, where s may be selected in C.2.1.

C.3.3 for each lεY may compute Cₗ=h^{q}^{ₗ}⁽⁰⁾,Cₗ′=(ATT)(l))^{q}^{ₗ}⁽⁰⁾, where qₗ(.)may be the polynomial associated with l.

C.3.4 may form the ciphertext as (T, C₀=M. e(g, g)^{a.s}, C₀′=g^{s}, ∀lεY: {Cₗ=h^{q}^{ₗ}⁽⁰⁾,Cₗ′=H(ATT(l))^{q}^{ₗ}⁽⁰⁾}).

D. Decrypt(C,SK): This may be the decryption function, which may be a recursive procedure. It may takes as input a ciphertext C and a secret key SK.

D.1 may invoke DecryptNode_{R}(C,SK) on the root node R of the tree T of C, where DecryptNodeₓ(C,SK) of a node x of T may be defined as follows:

D.1.1 may parse the ciphertext as C=(T, C₀, C₀′, ∀lεY: {Cₗ,Cₗ′}), and the secret key SK associated with a set S of attributes as SK=[K₀=g^{a}h^{r}, {Kⱼ=g^{r}H(j)^{r}^{ⱼ}, Kⱼ′=h^{r}^{ⱼ}}_{∀jεS].}

D.1.2 may be as follows: If the node x is a leaf node then we let i=att(x) and D.1.2 may proceeds as follows:

D.1.2.1 may be as follows. If iεS, then DecryptNodeₓ

$$( C , SK ) = \frac{e ( {K}_{i} , {C}_{i} )}{e ( {K}_{{i}^{′}} , {C}_{{i}^{′}} )} ,$$

where Kᵢ, Kᵢ′ and Cᵢ, Cᵢ′ may be the corresponding elements in SK and C, respectively. Further,

$$\frac{e ( {K}_{i} , {C}_{i} )}{e ( {K}_{{i}^{′}} , {C}_{{i}^{′}} )} = \frac{e ( {g}^{r} \cdot {H ( i )}^{{r}_{j}} , {h}^{{q}_{l} ( 0 )} )}{e ( {h}^{{r}_{j}} , {H ( i )}^{{q}_{l ( 0 )}} )} ,$$

according to B.3.2 and C.3.3. Even further,

$$\frac{e ( {g}^{r} \cdot {H ( i )}^{{r}_{j}} , {h}^{{q}_{l} ( 0 )} )}{e ( {h}^{{r}_{j}} , {H ( i )}^{{q}_{l ( 0 )}} )} = {e ( g , h )}^{r \cdot {q}_{l} ( 0 )}$$

by removing e(H(i),h)^{q}^{ₗ}^{(0)r}^{ⱼ} from both the numerator and the denominator.

D.1.2.2 may be as follows: If iεS, then DecryptNodeₓ(C,SK)=⊥, wherein ⊥ may denote an error symbol.

D.1.3 may be as follows: If the node x is a non-leaf node, then D.1.3 may proceed as follows:

D.1.3.1 may call DecryptNode_{z}(C,SK) for each child node z of x, and may store the output as F_{z}.

D.1.3.2 may be as follows. Let Sₓ be an arbitrary tₓ-sized set of child nodes z such that F_{z}≠⊥. If no such set exists then the node was not satisfied and F_{z}=⊥.

D.1.3.3 otherwise, may computes F_{z} as

$${F}_{z} = {\prod }_{z ∈ {S}_{x}}^{ } {F}_{Z}^{{Δ}_{i , {S}_{x}^{′}} ( 0 )} ,$$

where i=index(z), Sₓ′={index(z): zεSₓ}, which may be further computed as:

$${\prod }_{z ∈ {S}_{x}}^{ } {( {e ( g , h )}^{r \cdot {q}_{z} ( 0 )} )}^{{Δ}_{i , {S}_{x}^{′}} ( 0 )} = {\prod }_{z ∈ {S}_{x}}^{ } {( {e ( g , h )}^{r \cdot {q}_{PARENT ( z )} ( INDEX ( z ) )} )}^{{Δ}_{i , {S}_{x}^{′}} ( 0 )} = {\prod }_{z ∈ {S}_{x}}^{ } {( {e ( g , h )}^{r \cdot {q}_{x ( i )}} )}^{{Δ}_{i , {S}_{x}^{′}} ( 0 )} = {e ( g , h )}^{r \cdot {q}_{x} ( 0 )}$$

D.2 may be as follows: If the tree is satisfied by S, DecryptNode_{R}(C,SK)=e(g,h)^{r.q}^{_{R}}^{(0)=e(g,h)}^{r.s}=A according to D.1.3.3, where q_{R(.)} may be the polynomial associated with the root node R.

D.3 may compute

$$\frac{{C}_{0}}{e ( {K}_{0} , {C}_{{0}^{′}} ) / A} = \frac{{C}_{0}}{e ( {g}^{α} {h}^{r} , {g}^{s} ) / {e ( g , h )}^{r \cdot s}} = \frac{M \cdot {e ( g , g )}^{α \cdot s}}{{e ( g , g )}^{α \cdot s}} = M .$$

According to various embodiments, an additional, special, single-valued attribute may be provided in the system, which may be NilAtt (i.e., a dummy attribute). This NilAtt attribute may be assigned a constant value across the system (e.g., 0). The helper key of a legitimate user may be exactly issued upon this NilAtt attribute. For example, suppose a user originally has a set of attribute S, then now S̅=S∪{NilAtt}.

Referring to the above KeyGen method, the secret decryption key issued to the user may be still the same, upon the original set S. The corresponding helper key may be computed as (g^{r}H(NilAtt)^{r}^{ⱼ}, h^{r}^{ⱼ}) , which may treat the NilAtt attribute as an extra attribute.

To make the helper key indispensable in the decryption process, the access tree constructed in the encryption algorithm may be as follows.

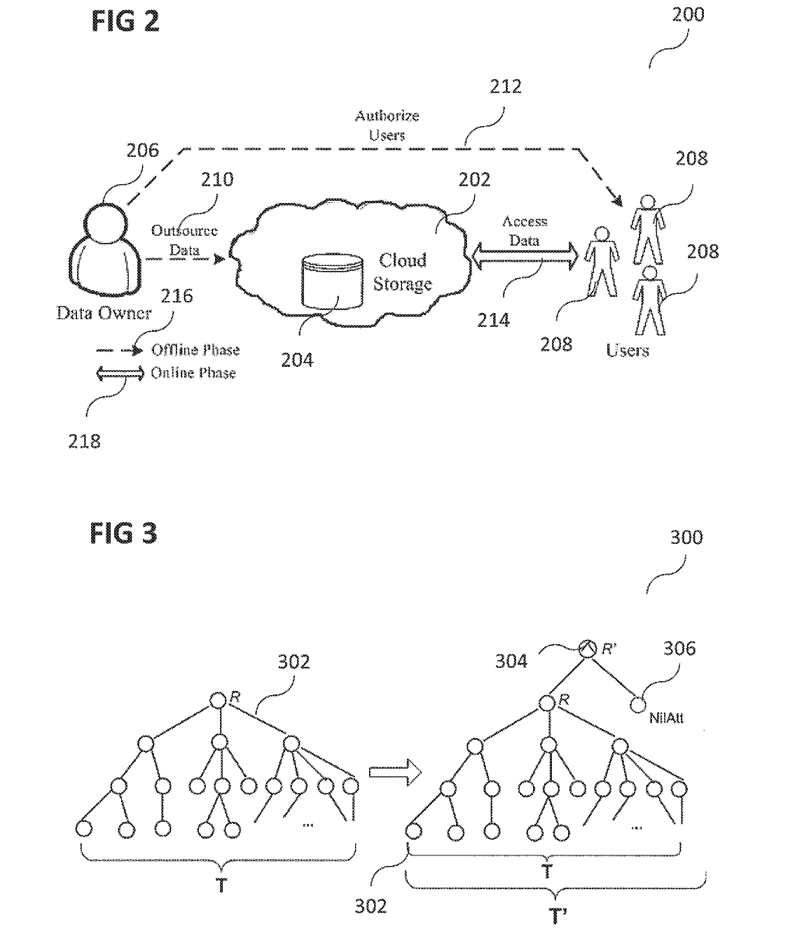

FIG. 3 shows an illustration 300 depicting the construction of T′ from NilAtt and T. Suppose that the original access tree is T 302 (shown on the left hand side of FIG. 3), rooted at R, then an access tree T′ (on the right hand side of FIG. 3) may be constructed with T 302 as a subtree as follow: let R′ 304 be the root of T′, then R′ 304 has R 302 and the NilAtt attribute 306 as its two child nodes, and R′ is an AND gate.

Encryption may then be performed with respect to T′. As a result, according to the above CP-ABE scheme, both DecryptNode_{NilAtt}(C,SK) and DecryptNode_{R}(C,SK) may be needed so as to compute DecryptNode_{R′}(C,SK).

Using the above proposed CP-ABE, the method of establishing fine-grained revocable access control for cloud storage services may be as follows:

A. System Initialization: In this phase, the data owner (DO) may establish system parameters.

A.1 may execute CP-ABE.Setup to generate PK and MK.

A.2 may publish PK.

B. User Authorization: The DO may authorize a user's access rights by issuing a secret key corresponding to her attributes set S.

B.1 may take as input a set S of attributes of a user U, and the master key MK.

B.2 may execute CP-ABE.KeyGen(MK,S∪{NilAtt}) to generate secret key SK=(K₀, ∀jεS∪{NilAtt}:{Kⱼ=g^{r}H(j)^{r}^{_{J}}, Kⱼ′=h^{r}^{ⱼ}, where the format of SK may be defined in the above B.3 of CP-ABE.KeyGen.

B.3 may secretly deliver (g^{r}H(NilAtt)^{r}^{ⱼ},h^{r}^{ⱼ}), the element corresponding to the NilAtt attribute, to the cloud as the user U's helper key.

B.4 may give the remaining elements to the user U as the personal secret decryption key.

C. Data Outsourcing: In this step, the data owner DO may outsource a record M (in other words: data) to the cloud.

C.1 may construct an access tree T as per the access policy to be imposed up the record.

C.2 may construct an extended access tree T′ from T together with the NilAtt attribute, following the above idea.

C.3 may execute CP-ABE.Encrypt(PK, M, T′) to generate a ciphertext C, where the format of C may be defined in the above C.3.3 of CP-ABE.Encrypt.

C.4 may upload C to the cloud.

D. Data Retrieval: In this step, the cloud may reply to a user's request for a ciphertext C.

D.1 may parse C as C=T′, C₀=M. e(g, g)^{a.s}, C₀′=g^{s}, ∀lεY:{Cₗ=h^{q}^{ₗ}⁽⁰⁾, Cₗ′=H(ATT(l))^{q}^{ₗ}⁽⁰⁾}.

D.2 may executes CP-ABE.DecryptNode_{NilAtt}(C,SK)=F_{NilAtt} as the pre-decryption operation using the user's helper key. It is to be noted that although the cloud does not know the entire SK, the user's helper key suffices to accomplish CP-ABE.DecryptNode_{NilAtt}(C, SK).

D.3 may return F_{NilAtt} together with C to the user.

D.4 may be as follows: At the user side, the user may compute DecryptNode_{R}′(C,SK) with her personal decryption secret key and F_{NilAtt}.

E. User Revocation: In this step, the data owner DO may revoke a user U's access privileges.

E.1 may be as follows: DO may instruct the cloud to delete U's helper key.

In the following, an embodiment (which may also be referred to as “Instantiation 2”) will be described. Conditional proxy re-encryption may aim at restricting the transferring capability of the proxy in proxy re-encryption, such that re-encryption may succeed only if the prescribed conditions are met. Earlier conditional proxy re-encryption schemes may only cope with simple, keyword-based conditions, where both the condition and the attributes may be a keyword. An attribute-based conditional proxy re-encryption scheme may be provided which may support fine-grained conditions beyond the keyword-based ones. Following the naming convention of key-policy attribute-based encryption (KP-ABE) and ciphertext-policy attribute-based encryption (CP-ABE), attribute-based conditional proxy re-encryption may be distinguished between key-condition conditional proxy re-encryption (KC-CPRE) and ciphertext-conditional proxy re-encryption (CC-CPRE). In the former, a re-encryption key may be associated with a policy, while a ciphertext may be associated with a set of attributes; the latter works the other way around.

According to various embodiments, a ciphertext-condition conditional proxy re-encryption (CC-CPRE) may be provided, where a ciphertext may be associated with a policy, while the re-encryption key may be associated with a set of attributes. Like the advantage of CP-ABE (over KP-ABE), CC-CPRE may be more natural and realistic than KC-CPRE, as the former may allow the encryptor to directly define the condition under which a ciphertext may be transformed.

Formally, a ciphertext-condition conditional proxy re-encryption (CC-CPRE) scheme may include the following sub-methods:

-Setup(1^{κ}): On input a security parameter 1^{κ}, the setup method may output a global parameter param, which may include the message space M. For brevity, we it may be assumed that param is implicitly included in the input of the rest method.

KeyGen(1^{κ}): All parties may use this randomize key generation algorithm to generate a public/private key pair (pkᵢ, skᵢ).

ReKeyGen(skᵢ,att, pkⱼ): On input of the delegator's private key skᵢ, a set of attributes att and the delegatee's public key pⱼ, the re-encryption key generation algorithm may outputs a re-encryption key

$$r {k}_{{att}_{i j}} .$$

Enc₂(pk,m,con): On input of a public key pk, a plaintext mεM and a condition con, this second encryption method may output a second level ciphertext CT, which can be re-encrypted into a first level one (intended for a possibly different receiver) using the suitable re-encryption key.

Enc₁(pk,m): On input of a public key pk and a plaintext mεM, this first encryption method may output a first level ciphertext CT that cannot be re-encrypted for another party.

ReEnc

$$( {CT}_{i} , r {k}_{{i \to j}^{att}} ) \text{:}$$

On input of a second level ciphertext CTᵢ associated with con under public key pkᵢ, and a re-encryption key

$$r {k}_{{i \to j}^{att}} ,$$

this re-encryption method, run by the proxy, may output a first level ciphertext CTⱼ under public key pkⱼ if att∝con, where att∝con may denote att satisfies the condition con embedded in CTᵢ.

Dec₂(CT,sk): On input of a second level ciphertext CT and a private key sk, this second decryption method may output a message m or the error symbol ⊥.

Dec₁(CT,sk): On input of a first level ciphertext CT and a private key sk, this first decryption method may output a message m or the error symbol ⊥.

The correctness of CPRE may mean that, for any condition con, any set of attributes att, any message mεM , and any couple of private/public key pairs (pkᵢ, skᵢ), (pkⱼ, skⱼ), it may hold that

Dec₂(Enc₂(pkᵢ,m,con),skᵢ)=m,Decᵢ(Enc₁(pkᵢ, m),skᵢ)=m

Dec₁(ReEnc(Enc₂(pkᵢ,m, con), ReKeyGen(skᵢ, att, pkⱼ)),skⱼ)=m if att∝con.

A detailed method according to various embodiments may be defined as follows. Let the Lagrange coefficient Δ_{i,S} for iεZₚ and a set S of elements in Zₚ be

$${Δ}_{i , S} = {\prod }_{j ∈ S , j \neq i} \frac{x - j}{i - j} .$$

Details of the scheme according to various embodiments will be described below.

A. Setup(1^{κ}}: This method may set up system parameters.

A.1 may takes as input a security parameter 1^{κ}.

A.2 may determine a bilinear map e: G×G→G₀, where G and G₀ may be cyclic groups of order p, where p may be a κ-bit prime number.

A.3 may select random elements g, h from the foresaid G, which may then be generators of G.

A.4 may determine a cryptographic hash function H: {0,1}→G, where G may be as foresaid.

B. KeyGen(Uᵢ): This method may generate public/private key pair for user Uᵢ.

B.1 may take as input user identity Uᵢ.

B.2 may pick a random element xᵢ from Zₚ*, p is the foresaid prime number.

B.3 may compute and set the public key pkᵢ=g^{x}^{ᵢ}.

B.4 may set the private key to be skᵢ=xᵢ.

C. ReKeyGen(skᵢ, att, pkⱼ). This method may generate a re-encryption key

$$r {k}_{{i \to j}^{att}}$$

from Uᵢ to Uⱼ corresponding the attribute set att.

C.1 may take as input skᵢ, the private key of Uᵢ and att, pkⱼ, which may be the set of attributes and public key of Uⱼ.

C.2 may pick random number a, r from Zₚ*, may compute g^{a}^{_{/xi}}, h^{r} and Eₚₖ_{ⱼ} (a), where Eₚₖ_{ⱼ} (a) may be a standard ElGamal encryption under pkⱼ.

C.3 for each lεatt, may pick a random number rₜ′ from Zₚ*, and may compute pkᵢ^{r}.H (attₗ)^{r}^{ₗ}′, where pkᵢ may be Uᵢ's public key and r may be selected in C.2.

$$C .4 may set r {k}_{{x \to j}^{att}} = ( {g}^{α / {x}_{i}} \cdot {h}^{r} , {E}_{pkj} ( α ) , ∀ l ∈ att \text{:} \{ p {k}_{i}^{r} \cdot {H ( {att}_{l} )}^{{r}_{{l}^{′}}} , {h}^{{r}_{{l}^{′}}} \} ) .$$

D. Enc₂(pk,m,con): This method may generate a second level ciphertext.

D.1 may take as input a public key pk, a message m, and a condition con, which may be represented as an access tree T.

D.2 may select a polynomial qₓ for each node x (including the leaves) in the tree T, and the degree dₓ of qₓ may be set to be 1 less than the threshold value tₓ of that node, i.e., dₓ=tₓ−1. Specifically, these polynomials may be chosen in a top-down manner, starting from the root node R.

D.2.1 may, for the root node R, select a random number s in Zₚ*, and may set q_{R}(0)=s, where q_{R}(.)=s may be the polynomial for R.

D.2.2 may select d_{R} other random points of the polynomial q_{R} to define it completely.

D.2.3 for any other node x, may set qₓ(0)=qₚₐᵣₑₙₜ₍ₓ₎(index(x)) and may choose dₓ other points randomly to completely define qₓ.

D.3 may be as follows. Let Y be the set of leaf nodes in T. D.3 may compute the ciphertext C as follows.

D.3.1 may compute m. e(g, g)^{s}, where s may be determined in D.2.1.

D.3.2 for each lεY, may compute) pkᵢ^{q}^{ₗ}⁽⁰⁾, h^{q}^{ₗ}^{)o)}, H(l)^{q}^{ₗ}⁽⁰⁾, where qₗ(.) may be the polynomial associated with l.

D.3.3 may set C=(T, m. e(g, g)^{s}, ∀lεY:){pkᵢ^{q}^{ₗ}⁽⁰⁾, h^{q}^{ₗ}⁽⁰⁾, H(l)^{q}^{ₗ}⁽⁰⁾}).

E. Enc₁(pk,m): This method may generates a first level ciphertext C.

E.1 may take as input a public key pk, a message m.

E.2 may pick random number s in Zₚ*, and may compute m. e(g, g)^{s}.

E.3 may pick a random number aεZₚ*, and may compute e(g, g)^{a} and Eₚₖ(a), where Eₚₖ(.) may be standard ElGamal encryption under pk.

E.4 may set C=(m. e (g, g)^{s}, e(g, g)^{a.s}, Eₚₖ(a))

F. ReEnc

$$( {C}_{i} , r {k}_{{att}_{i j}} )$$

:This method may re-encrypt a second level ciphertext into a first level ciphertext.

F.1 may takes as input a second level ciphertext Cᵢ associated with condition con under public key pkᵢ, and a re-encryption key

$$r {k}_{{att}_{i j}} .$$

F.2 may parse Cᵢ as C=(T, C₀, ∀lεY:{Cₗ_{₁}, Cₗ_{₂},Cₗ_{₃}}), and

$$r {k}_{{att}_{i j}} as r {k}_{{att}_{i j}} = ( {K}_{0} , {K}_{0}^{′} , ∀ l ∈ att \text{:} \{ {K}_{{l}_{1}} , {K}_{{l}_{2}} \} )$$

associated with a set of attributes att.

F.3 may invoke ReEncNode_{R}

$$( {C}_{i} , r {k}_{{att}_{i j}} )$$

on the root node R of the tree T, where ReEncNode_{R}

$$( {C}_{i} , r {k}_{{att}_{i j}} )$$

of a node x of T may be defined below.

F.3.1 may be as follows. If the node x is a leaf node then we let l=ATT(x).

F.3.1.1 may be as follows. If lεatt, then ReEncNodeₓ

$$\begin{matrix}( {C}_{i} , r {k}_{{i \to j}^{att}} ) = \frac{e ( {K}_{0} , {C}_{{l}_{1}} ) \cdot e ( {K}_{{l}_{2}} , {C}_{{l}_{3}} )}{e ( {K}_{{l}_{1}} , {C}_{{l}_{2}} )} \\ = \frac{e ( {g}^{α / {x}_{i}} \cdot {h}^{r} , {g}^{{x}_{i} \cdot {q}_{l ( 0 )}} ) \cdot e ( {h}^{{r}_{{l}^{′}}} , {H ( l )}^{{q}_{l} ( 0 )} )}{e ( {g}^{{x}_{i} \cdot r} \cdot {H ( l )}^{{r}_{{l}^{′}}} , {h}^{{q}_{l} ( 0 )} )} \\ = {e ( g , g )}^{α \cdot {q}_{l} ( 0 )}\end{matrix}$$

F.3.1.2 may be as follows. If l∉att, then ReEncNodeₓ(.,.) =^{1⊥.}

F.3.2 may be as follows. If x is a non-leaf node, then for each child node z of x, F.3.2 may call ReEnc_{z}

$$( {C}_{i} , r {k}_{{att}_{i j}} )$$

and may store the output as F_{z}. Let Sₓ be an arbitrary tₓ-sized set of child nodes z such that F_{z}≠⊥.

F.3.2.1 may be as follows. If no such set exists then the node was not satisfied and the function may return ⊥.

F.3.2.2 otherwise, may compute F_{z} as

$${F}_{z} = {\prod }_{z ∈ {S}_{x}}^{ } {F}_{Z}^{{Δ}_{i , {S}_{x}^{′}} ( 0 )} ,$$

where i=index(z), Sₓ′={index(z): zεSₓ}, which further may be

$${F}_{z} = {\prod }_{z ∈ {S}_{x}}^{ } {( {e ( g , g )}^{α \cdot {q}_{z} ( 0 )} )}^{{Δ}_{i , {S}_{x}^{′}} ( 0 )} = {\prod }_{z ∈ {S}_{x}}^{ } {( {e ( g , g )}^{α \cdot {q}_{PARENT ( z )} ( INDEX ( z ) )} )}^{{Δ}_{i , {S}_{x}^{′}} ( 0 )} = {\prod }_{z ∈ {S}_{x}}^{ } {( {e ( g , g )}^{α \cdot {q}_{x ( i )}} )}^{{Δ}_{i , {S}_{x}^{′}} ( 0 )} = {e ( g , g )}^{α \cdot {q}_{x} ( 0 )}$$

F.4 may be as follows: If the tree T is satisfied by att, F.4 may compute

$${ReEnc}_{R} ( {C}_{i} , r {k}_{{att}_{i j}} ) = {e ( g , g )}^{α \cdot {q}_{R} ( 0 )} = {e ( g , g )}^{α \cdot s} = A .$$

F.5 may set the resulting first level ciphertext Cⱼ as Cⱼ=[C₀, A, K₀′]=[m. e(g, g)^{s}, e(g, g)^{a.s}, Eₚₖ_{ⱼ}(a)].

G. Dec₂(C, sk): This method may decrypt a second level ciphertext.

G.1 may take as input a private key sk and a second level ciphertext C.

G.2 may parse C as C=(T, m. e(g,g)^{s}, ∀lεY:{pkᵢ^{q}^{ₗ}⁽⁰⁾, h^{q}^{ₗ}⁽⁰⁾, H(l)^{q}^{ₗ}⁽⁰⁾}), where Y may be the set of leaf nodes in T.

G.3 may compute pkᵢ^{s} from {pkᵢ^{q}^{ₗ}⁽⁰⁾}_{lεY} following the access tree T.

G.4 may compute

$$m = \frac{m \cdot {e ( g , g )}^{s}}{e ( {( p {k}_{i}^{s} )}^{{sk}^{- 1}} , g )} .$$

H. Dec₁(C, sk): This method may decrypt a first level ciphertext.

H.1 may take as input a private key sk and a first level ciphertext C.

H.2 may parse C as C=(m. e(g, g)^{s}, e(g, g)^{a.s}, Eₚₖ(a)).

H.3 may decrypt Eₚₖ(a) to get a.

H.4 may compute A=(e(g, g)^{a.s})^{a}^{^{−1}}=e(g, g)^{s}.

H.5 may compute

$$m = \frac{m \cdot {e ( g , g )}^{s}}{A} .$$

To apply the above conditional proxy re-encryption scheme in the second embodiment, the following steps may be provided:

A. System Initialisation: In this phase, the data owner (DO) may establish system parameters, and each user may generate a public/private key pair.

In A.1, the DO may execute CPRE.Setup(1^{κ}) to generate and publish the system parameters.

In A.2, each user U (including the data owner) may execute CPRE. Keygen(U) to generate a public/private key pair for herself

In A.3, a user U may publish her public key generated in A.2.

B. User Authorisation: In this phase, the data owner (DO) may authorize a user's access rights by generating a re-encryption key for the user.

B.1 may execute CPRE.Rekeygen(sk_{DO}, att_{U}, pk_{U}) to generate a re-encryption key

$${rk}_{{ {att}_{U}}_{DO U}}$$

from himself to herself to the user U, where sk_{DO} may be DO's private key, att_{U} may be U's attributes, and pk_{U} may be U's public key.

B.2 may secretly deliver

$${rk}_{{ {att}_{U}}_{DO U}}$$

to the cloud as the user U's helper key.

C. Data Outsourcing: In this step, the data owner DO may outsource a record M to the cloud.

C.1 may determine the access condition con associated with M.

C.2 may execute CPRE.Enc₂(pk_{DO},M,con) to generate a second level ciphertext C, where pk_{DO} may be the data owner DO's public key, M may be the record, and con may be the access condition defined in C.1.

C.3 may upload C to the cloud.

D. Data Retrieval: In this step, the cloud may reply to a user's request for a ciphertext C.

D.1, upon receipt of request for a data C from user U, may retrieve U's helper key

$${rk}_{{ {att}_{U}}_{DO U}} ,$$

where

$${rk}_{{ {att}_{U}}_{DO U}}$$

may be delivered in B.2 as long as U is an authorized user.

D.2 may execute CPRE.ReEnc

$$( C , {rk}_{{ {att}_{U}}_{DO U}} )$$

to generate a first level ciphertext C′.

D.3 may return C′ to the user U.

D.4 may be as follows. At the user side, the user U may execute CPRE.Dec₁(C′, sk_{U}) to get the plaintext, where C′ may be the first level ciphertext returned in D.3 and sk_{U} may be U's private key.

E. User Revocation: In this step, the data owner DO may revoke a user U's access privileges.

In E.1, DO may instruct the cloud to delete U's helper key.

This embodiment may have a salient advantage of user efficiency, since an authorized user only may need to decrypt a first level ciphertext to get the requested data. The user simply may perform standard exponentiation operations. This may make it possible for users to use hand-held devices to access the cloud, as regular public key operations have already been proven feasible on weak devices with limited resources.

According to various embodiments, a user efficient scheme may be provided for a fine-grained access control solutions for cloud storage, which may enjoy attribute-based level of fine-grained-ness.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for providing requested data from a storage device to a data consumer, the method comprising:
determining a helper key for the data consumer;
determining encrypted data corresponding to the requested data from a memory of the storage device;
determining pre-processed data based on the encrypted data and the helper key, wherein the pre-processed data is encrypted and configured to be decrypted using a private key of the data consumer; and
transmitting the pre-processed data to the data consumer.

2. The method of claim 1,
wherein the helper key is specific for the data consumer.

3. The method of claim 1, further comprising:
receiving the encrypted data from a data owner.

4. The method of claim 1, further comprising:
determining the helper key from a data owner based on attributes of the data consumer and a master key.

5. The method of claim 1, further comprising:
determining the encrypted data based on a tree-structure based on user attributes.

6. The method of claim 1,
wherein the tree-structure comprises a root node with a tree-structure based on the user attributes as a sub-tree and a dummy attribute as an extra leaf

7. The method of claim 1,
wherein the pre-processed data is configured to only be decrypted using the private key of the data consumer.

8. The method of claim 1, further comprising:
determining the pre-processed data based on a pre-decryption of the encrypted data based on the helper key.

9. The method of claim 1, further comprising:
determining the pre-processed data based on a re-encryption of the encrypted data based on the helper key.

10. The method of claim 1, further comprising:
receiving from a data owner an instruction to delete the helper key; and
deleting the helper key.

11. A storage device comprising:
a helper key determination circuit configured to determine a helper key for a data consumer requesting data;
an encrypted data determination circuit configured to determine encrypted data corresponding to the requested data from a storage of the storage device;
a pre-processed data determination circuit configured to determine pre-processed data based on the encrypted data and the helper key, wherein the pre-processed data is encrypted and configured to be decrypted using a private key of the data consumer; and
a transmitter configured to transmit the pre-processed data to the data consumer.

12. The storage device of claim 11,
wherein the helper key is specific for the data consumer.

13. The storage device of claim 11, further comprising:
a receiver configured to receive the encrypted data from a data owner.

14. The storage device of claim 11,
wherein the helper key determination circuit is further configured to determine the helper key from a data owner based on attributes of the data consumer and a master key.

15. The storage device of claim 11,
wherein the pre-processed data determination circuit is further configured to determine the encrypted data based on a tree-structure based on user attributes.

16. The storage device of claim 11,
wherein the tree-structure comprises a root node with a tree-structure based on the user attributes as a sub-tree and a dummy attribute as an extra leaf

17. The storage device of claim 11,
wherein the pre-processed data is configured to only be decrypted using the private key of the data consumer.

18. The storage device of claim 11,
wherein the pre-processed data determination circuit is further configured to determine the pre-processed data based on a pre-decryption of the encrypted data based on the helper key.

19. The storage device of claim 11,
wherein the pre-processed data determination circuit is further configured to determine the pre-processed data based on a re-encryption of the encrypted data based on the helper key.

20. The storage device of claim 11, further comprising:
a receiver configured to receive from a data owner an instruction to delete the helper key; and
a helper key deletion circuit configured to delete the helper key.
